(19) United States
(12) Patent Application Publication
(10) Pub. No.: US 2009/0229233 A1
(43) Pub. Date: Sep. 17, 2009

(54) Agricultural harvesting machine with a transfer device

(76) Inventors: Manfred POLLKLAS, Rheda-Wiedenbrueck (DE); Ralf HARTMANN, Melle (DE)

Correspondence Address: MICHAEL J. STRIKER, 103 EAST NECK ROAD, HUNTINGTON, NY, 11743, US

(21) Appl. No.: 12/399,104

(22) Filed: Mar. 6, 2009

(30) Foreign Application Priority Data
Mar. 13, 2008 (DE) 102008014001.5

(51) Int. Cl. A01D 41/127; A01D 61/00; A01D 41/02; A01D 41/12

(52) U.S. Cl. 56/10.2 R; 460/114

(57) ABSTRACT

An agricultural harvesting machine for picking up and processing crop material includes a transfer device which is swivelable about a horizontal axis and a vertical axis for transferring crop material to a hauling vehicle, and the transfer device of the harvesting machine—which is performing the harvesting operation—is swiveled manually and/or automatically against the direction of travel of the harvesting machine as a function of operating criteria.

### CROSS-REFERENCE TO RELATED APPLICATION

The invention described and claimed hereinbelow is also described in German Patent Application DE 10 2008 014 001.5 filed on Mar. 13, 2008. This German Patent Application, whose subject matter is incorporated here by reference, provides the basis for a claim of priority of invention under 35 U.S.C. 119(a)-(d).

### BACKGROUND OF THE INVENTION

The present invention relates to an agricultural harvesting machine which includes a transfer device for transferring crop material to a hauling device.

Self-propelled harvesting machines such as forage harvesters or combine harvesters typically include a transfer device which is used to transfer the harvested crop material to a hauling vehicle or a storage container. In the case of a forage harvester, for example, the crop material is transferred continually during the harvesting operation using the transfer device to a hauling vehicle which is traveling alongside it. To accomplish this, the hauling vehicle must be driven parallel to or alongside the forage harvester. The operator of the forage harvester must constantly check the position of the hauling vehicle relative to the forage harvester to ensure that the crop material is transferred exactly and without loss. In the simplest case, the position of the transfer device itself or the transfer-device cover which is situated at the end of the transfer device must be controlled manually by the operator of the harvesting machine.

When the harvesting machine is driven out of the crop stand, in particular into the headland, the harvesting machine is accelerated and is typically driven away from the hauling vehicle which was traveling alongside it, so that, after a turnaround maneuver has been carried out, it may re-enter the crop stand. When the headland is reached, the self-propelled forage harvester typically accelerates before the hauling vehicle which is traveling alongside it. If the ground speed of the hauling vehicle remains constant initially during the acceleration phase of the harvesting machine, then, due to the resultant change in position of the transfer device relative to the hauling vehicle, the crop material remaining inside the harvesting machine will not be transferred to the storage container of the hauling vehicle, but rather to the ground, thereby resulting in a significant loss of crop material over the entire harvesting operation.

The same problem occurs when gaps in crop stands are driven across. In this harvesting situation, the operator of the harvesting machine increases the ground speed of the harvesting machine—in a brief acceleration phase—beyond a previously specified setpoint harvesting driving speed until the gap in the crop stand has been traversed, and then continues in the crop stand at the setpoint harvesting driving speed. Via the acceleration of the ground speed of the harvesting machine, the position of the transfer device relative to the hauling vehicle also changes, since the operator of the hauling vehicle perceives the acceleration of the harvesting machine in a time-delayed manner, with the result that, in this harvesting situation as well, the crop material remaining to be transferred is also dumped onto the ground, or, in a worst case scenario, is dumped onto the hauling vehicle itself.

EP 1 454 520 A1 discloses a device for controlling the transfer device on an agricultural harvesting machine that shifts the position of the transfer device as a function of the position of a first actuator relative to the position of a second actuator in order to better transfer the crop material to a hauling vehicle, the position of the actuator determining the position of the transfer device. The disadvantage of this design of the control is that the operator—in particular when exiting the crop stand, in particular when driving into the headland—must still control the transfer device and coordinate it with the hauling vehicle which is traveling alongside or behind it, to ensure that the crop material may be transferred without loss. Since, however, the operator of the harvesting machine must concentrate on maneuvering the harvesting machine when exiting the crop stand, much of the crop material will be discharged past the hauling vehicle and will fall onto the ground as waste.

### SUMMARY OF THE INVENTION

The object of the present invention, therefore, is to avoid the disadvantages of the cited prior art and to enable the transfer process of the agricultural harvesting machine to be carried out without waste in harvesting situations such as driving in the headland or when crossing gaps in crop stands.

In keeping with these objects and with others which will become apparent hereinafter, one feature of the present invention recites, briefly stated, in an agricultural harvesting machine for picking up and processing crop material, comprising a transfer device which is swivelable about a horizontal axis and a vertical axis, for transferring crop material to a hauling vehicle, said transfer device being swivelable in a manner selected from the group consisting of manually, automatically, and both against a direction of travel of the harvesting machine as a function of operating criteria.

Given that the transfer device of an agricultural harvesting machine which is performing a harvesting operation may be swiveled manually and/or automatically against the direction of travel of the harvesting machine as a function of operating criteria, it is ensured that the change in the transfer position—which occurs in harvesting situations such as driving in the headland or crossing gaps in crop stands, since, in particular, the harvesting machine accelerates sooner than does the hauling vehicle—is compensated for, thereby preventing the transferring losses that typically occur. In addition, there is no need to use expensive sensor systems to control the transfer device in order to offset transfer losses of this type.

Given that the operating criteria, based on which the swiveling of the transfer device and/or the adjustment of the swiveling speed is carried out, are the ground speed and/or the acceleration of the harvesting machine, and/or the crop material throughput quantity, and/or the steering angle of the harvesting machine, and/or the change in the relative speed between the harvesting machine and the hauling vehicle, they may be taken into consideration to make deductions about the harvesting situation, according to which a different transfer position may occur as compared to the normal harvesting operation, e.g. when the harvesting machine reaches the headland during the harvesting operation or when it crosses gaps in crop stands.

In these harvesting situations, the harvesting machine is typically accelerated and exceeds a predefined setpoint harvesting driving speed, a situation which the operator of the hauling vehicle notices in a time-delayed manner. Deductions regarding the described harvesting situation may also be made by taking the throughput quantity of crop material into account, since the crop material throughput decreases in particular when the headland or gaps in the crop stand is/are reached. In addition, when the headland is reached, the harvesting machine is typically turned away from the hauling vehicle in order to initiate a turnaround maneuver; it is therefore advantageously possible to also use the steering angle of the harvesting machine as an operating criterium.

In an advantageous development of the present invention, the harvesting machine includes an evaluation and control unit for controlling the transfer device, via which the swiveling procedure and/or the control/regulation of the swiveling speed of the transfer device opposite to the direction of travel are/is carried out automatically as a function of the operating criteria; manual control by the operator would also be feasible so that the operator may control and regulate the swiveling procedure against the direction of travel quickly and in an individualized manner depending on the assessment of the particular harvesting situation, in order to prevent losses from the transfer procedure.

To ensure that the operating criteria may be determined, the agricultural harvesting machine includes suitable means which may be designed as sensors, and which provide signals, as a function of which harvesting situations may be detected in which losses from the transfer procedure may occur due to a change in the transfer position of the harvesting machine relative to the hauling device of the hauling vehicle which is driving alongside.

It is feasible that the means which are used to determine the operating criteria is an electrooptical device which is located on the harvesting machine, and which may be designed in particular as a camera, thereby making it possible, e.g. to easily determine the change in the relative position of the harvesting machine relative to the hauling vehicle.

In an advantageous development of the present invention, the evaluation and control unit includes control means which make it possible to control the transfer device as a function of the signals provided in a manner such that an impact point of the crop material flow on the hauling device of the hauling vehicle, which was set before swiveling was carried out, remains essentially constant.

It is ensured that transfer-related losses are effectively prevented in the harvesting situations described above by swiveling the transfer device against the direction of travel when—in the situation in which the transfer device is typically in its lateral transfer position simultaneously with the start of the acceleration phase of the harvesting machine, which is above the predefined setpoint harvesting driving speed—signals which are generated by the sensor in order to determine the harvesting driving speed are transferred to the evaluation and control device, and the swiveling of the transfer device against the direction of travel is controlled by the evaluation and control unit as a function of the signals.

It has proven particularly practical to integrate the process for swiveling the transfer device against the direction of travel in an existing electronic headland management system which is used to activate the swiveling of the transfer device against the direction of travel in particular when the headland management system senses that the harvesting machine is being accelerated above a predefined setpoint harvesting driving speed while traveling in the headland, thereby making it possible to automate the swiveling procedure overall, to relieve the operator considerably, and to prevent transfer-related losses.

To ensure that the harvesting machine may resume—as quickly as possible—a predefined transfer position which is used during the normal harvesting operation, the swiveling procedure of the transfer device against the direction of travel is stopped when the conveyance of crop material has ended.

It has proven particularly practical and user-friendly for the evaluation and control unit to be activatable using a touch sensor device, and for the activated control to be displayable using an optical and/or acoustic reporting device which is located in the driver's cab of the agricultural harvesting machine, thereby ensuring that the operator remains informed of the swiveling procedure at all times, and so that the operator may intervene in the swiveling procedure and the control of the swiveling procedure manually if necessary.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a top view of a forage harvester and, traveling alongside it, a tractor which includes an adapted hauling device, as they travel in the headland.

FIG. 2 shows a top view of a forage harvester and, traveling alongside it, a tractor which includes an adapted hauling device, as they cross a gap in a crop stand in the field to be harvested.

### DESCRIPTION OF THE PREFERRED EMBODIMENTS

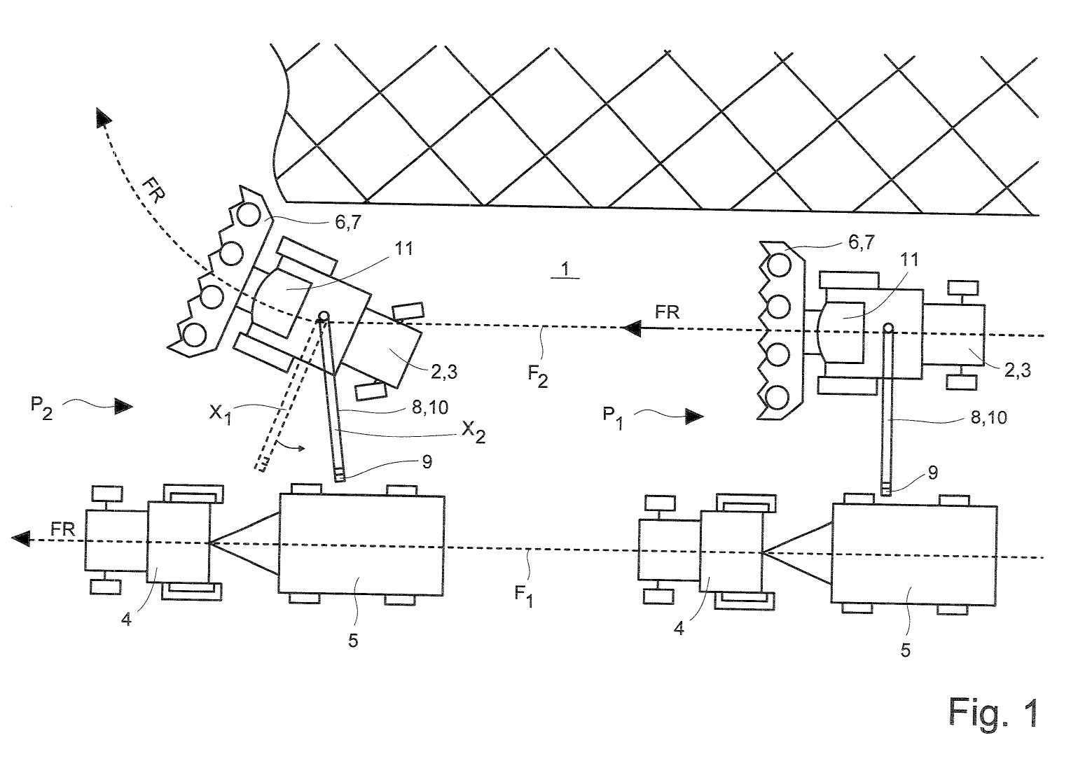

FIG. 1 shows a top view of a field 1 to be harvested, where an agricultural harvesting machine 3 which is designed as a forage harvester 2, and a hauling vehicle 4 which includes an attached hauling device 5 are engaged in the harvesting process. A front attachment 6, which is a corn header 7 in the embodiment, is attached to the front of forage harvester 2, front attachment 6 cutting and collecting the crop material from field 1 to be harvested, and conveying it to processing units (not depicted). The chopped crop material is then transferred via upper discharge chute 8, which may be swiveled laterally and displaced vertically, to hauling device 5 which is drawn by hauling vehicle 4 which is traveling alongside it.

Via the position of discharge flap 9 which is situated on the end of upper discharge chute 8, it is possible to control the range, i.e., the distance between the input-side end of upper discharge chute 8 located on forage harvester 1 and the impact point of the crop material flow on hauling device 5 of hauling vehicle 4. When discharge flap 9 is swiveled downward, the range is shorter—given the same vertical position of upper discharge chute 8—than it is when discharge flap 9 is swiveled upward. The position of transfer device 10, which is designed as upper discharge chute 8, relative to the vehicle longitudinal axis is determined via a suitable sensor, e.g. an incremental sensor which detects rotational direction, and it is transmitted to an evaluation and control unit (not depicted). In the case of forage harvester 2, transfer device 10 is easily swiveled using a hydraulic motor, although it is feasible for other adjusting elements such as electric motors or hydraulic cylinders to be used. It is within the scope of the present invention for transfer device 10 to be designed to be telescoping, in order to realize greater transfer ranges.

In first harvesting situation P₁ shown, forage harvester 2 is driving straight ahead as it picks up crop material from field 1 to be harvested. The harvesting driving speed and/or the distance covered by harvesting machine 3 are/is measured by a sensor, which is not depicted. Transfer device 10, which is an upper discharge chute 8 in this case, is oriented in the embodiment such that it forms an angle of approximately 90° with the vehicle longitudinal axis of forage harvester 2 in order to transfer the crop material to hauling device 5 which is drawn by hauling vehicle 4. Hauling vehicle 4 with attached hauling device 5 is moving along a driving track F₁ which extends parallel to driving track F₂ of forage harvester 2, and it is guided relative to forage harvester 2 in a transfer position which is approximately constant. Forage harvester 2 and hauling vehicle 4—with attached hauling device 5—are now shown in second harvesting situation P₂, during travel in the headland. When the headland is reached, the operator typically accelerates harvesting machine 3 in order to initiate a turnaround maneuver, and front attachment 6 is moved out of a working position and into a non-working position (not depicted). Given that the operator of hauling vehicle 4 which is driving alongside perceives, in a time-delayed manner, that harvesting machine 3 has accelerated and/or that harvesting machine 3 has left its driving track F₂, the transfer distance between hauling vehicle 4 and harvesting machine 3 assumed during the harvesting operation changes.

Since it is very difficult for the operator of harvesting machine 3 to perform the turnaround maneuver while focusing on the process—which takes place in the headland—of transferring the crop material remaining in harvesting machine 3, transfer device 10 typically remains in position X₁ while it is traveling in the headland, position X₁ being depicted using a dashed line, and representing the position which transfer device 10 assumed during parallel travel in the harvesting operation. Due to the changing distance between harvesting machine 3 and hauling vehicle 4, undesired transfer-related losses occur when the crop material which remains in harvesting machine 3 is discharged onto the ground next to hauling vehicle 5, or, in the worst case scenario, is discharged directly onto hauling vehicle 4 which is pulling hauling device 5. It is also feasible for the operator of hauling vehicle 4 to abruptly brake hauling vehicle 4 when the headland is reached, in which case the transfer position also changes.

To avoid this disadvantage, according to the present invention, when harvesting machine 3 is in the harvesting mode, transfer device 10 is swiveled against direction of travel FR as a function of operating criteria of harvesting machine 3. In an evaluation and control unit, which is not depicted and which is assigned to harvesting machine 3, the setpoint harvesting driving speed, at the least, is predefined in order to calculate the control signals which are output to the adjusting elements to swivel transfer device 10 against direction of travel FR. Further operating criteria of the harvesting machine, such as the steering angle of harvesting machine 3 and/or the position of the front attachment during the harvesting operation, and/or the speed of harvesting machine 3 relative to hauling vehicle 4, and/or a previously defined transfer position may also be stored in the evaluation and control unit. This is typically carried out manually by the operator using suitable input means which are located in driver's cab 11.

Depending on sensors which are not depicted, the evaluation and control unit now receives signals from appropriate sensors, e.g. regarding the current harvesting driving speed, the position of the front attachment, and the current steering angle of the harvesting machine. If it is now determined that the actual harvesting driving speed exceeds the predefined setpoint harvesting speed, an output signal is generated by a program which is stored in the evaluation and control unit, and it is transmitted to the adjusting elements for swiveling transfer device 10, the evaluation and control unit now bringing about a positional control of transfer device 10 against direction of travel FR. The swiveling speed at which transfer device 10 is swiveled against direction of travel FR depends on the level of the acceleration value of harvesting machine 3 as it accelerates above the setpoint harvesting driving speed, so that, in harvesting situation P₂, the change in the distance between harvesting machine 3 and hauling vehicle 4 which occurs during the acceleration procedure is compensated for, and it is ensured that the crop material remaining in harvesting machine 3 will be transferred.

The point at which the transfer of the crop material remaining in harvesting machine 3 comes to an end is ascertained using at least one sensor which is located in the crop material channel. An appropriate signal is transmitted to the evaluation and control unit, and it is evaluated by the stored program; appropriate signals are then output to the adjusting elements of transfer device 10 to terminate the swiveling procedure. In one embodiment, the positional control of transfer device 10 against direction of travel FR may be designed such that the harvesting driving speed and/or the acceleration are taken into account, and such that the evaluation and control unit considers the steering procedure by considering the steering angle, as it controls transfer device 10 against the direction of travel of harvesting machine 3, thereby making it possible to compensate for the change in transverse distance between harvesting machine 3 and hauling vehicle 4—which also occurs—by controlling the transfer device accordingly. In addition, further operating parameters—which were mentioned above—of harvesting machine 3 may be utilized, e.g. a preset target position of the crop material flow onto hauling device 5, and the speed of harvesting machine 3 relative to the hauling vehicle, in order to control the procedure to swivel the transfer device against the direction of travel by accounting for deviations from predefined values for the operating criteria which are used to deduce a change—as compared to the normal harvesting operation—in the transfer position of the harvesting machine relative to the hauling vehicle.

It is also possible to assign an electrooptical device (not depicted) to the harvesting machine, and to position it such that it is situated downstream of transfer device 10 in the direction of material discharge and at least partly detects the crop material flow and hauling device 5 from a region on the top side. The electrooptical device may be positioned anywhere on transfer device 10. The electrooptical device is coupled to the evaluation and control unit using wires or in a wireless manner. If hauling vehicle 4 now reduces its speed or changes its position relative to harvesting machine 3 by exiting driving track F₁, this may be detected using the electrooptical device, and an appropriate signal may be forwarded to the evaluation and control unit, so that an appropriate output signal is sent to the adjusting elements in order to swivel transfer device 10 against direction of travel FR, in order to compensate for the change in distance between harvesting machine 3 and hauling vehicle 4 or hauling device 5—this change in distance being detected by the electrooptical device—, thereby ensuring that the transfer procedure may be carried out without loss.

In a further embodiment it is provided that the operator of harvesting machine 3 may be informed via an optical display in driver's cab 11 that no crop material remains in harvesting machine 3, so that the operator may terminate the swiveling procedure manually using suitable means, e.g. a button in driver's cab 11.

In a further embodiment, the swiveling procedure for swiveling transfer device 10 against direction of travel FR of harvesting machine 3 may be integrated in an electronic headland management system (not depicted) which is known per se, using which the headland working step sequences may be controlled automatically, wherein various headland working step sequences are typically learned by the operator switching the headland management system to a learning mode and performing a turnaround maneuver; the headland management system then detects and stores the individual working steps. According to the present invention, the above-mentioned operating criteria of harvesting machine 3 are taken into account by the electronic headland management system so that, in particular, the swiveling of transfer device 10 against direction of travel FR is activated when the headland management system detects deviations from the preset values of the operating criteria, e.g. the setpoint harvesting driving speed having been exceeded, which indicate that the distance between harvesting machine 3 and hauling vehicle 4 has changed. If it is determined using sensors that no crop material is being conveyed, this is also taken into account by the headland management system, and the swiveling procedure is automatically terminated, so that transfer device 10 may be swiveled back into its original transfer position X₁, so that, after the turnaround maneuver is carried out in the headland, the harvesting process which involves travelling parallel to hauling vehicle 4 may be continued.

It may also be provided that the evaluation and control unit is activatable using a touch sensor device in driver's cab 11 of harvesting machine 3, and that the activated control is displayable using an optical and/or acoustic reporting device in driver's cab 11 of harvesting machine 3, thereby ensuring that the operator remains informed of the swiveling procedure at all times, and so that the operator may intervene in the swiveling procedure and the control of the swiveling procedure manually if necessary.

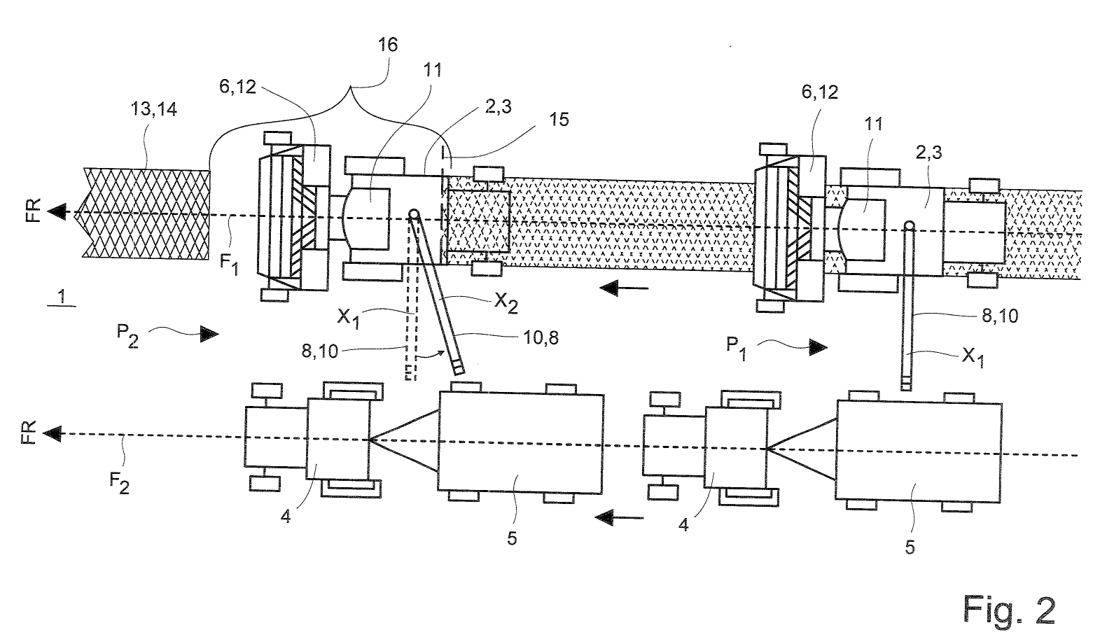

As in FIG. 1, FIG. 2 shows a top view of a field 1 to be harvested, where an agricultural harvesting machine 3 which is designed as a forage harvester 2, and a hauling vehicle 4 which includes an attached hauling device 5 are engaged in the harvesting process. In contrast to FIG. 1, FIG. 2 shows a front attachment 6 designed as a pickup 12 attached to the front of forage harvester 2. In first harvesting position P₁ shown, harvesting machine 3 moves on a driving track F₁ parallel to driving track F₂ in the same direction of travel FR as hauling vehicle 4, and it is moved toward it, in a transfer position. Driving track F₁ of forage harvester 2 is determined by the position of crop material 14 which is set down in swaths 13. Crop material 13, which is picked up from field 1 to be harvested by forage harvester 2 using pickup 12 is forwarded to processing units (not depicted) of forage harvester 2, and it is transferred using transfer device 10 which is designed as upper discharge chute 8 to hauling device 5 which is drawn by hauling vehicle 4. Transfer device 10 assumes a transfer position X₁ which is situated approximately at a right angle to the longitudinal axis of the vehicle. Forage harvester 2 is currently crossing a line 15 which is depicted as a dashed line, at the beginning of a gap 16 in the crop stand of crop material 14 which has been laid down in swaths 13.

At the same time, as is the case when driving in the headland as depicted in FIG. 1, harvesting machine 3 is usually accelerated briefly when it reaches gap 16 in crop stand, so that it may cross gap 16 in crop stand at a harvesting driving speed which is greater than the predefined setpoint harvesting driving speed; after a brief braking phase, forage harvester 2 continues to pick up crop material from field 1 to be harvested at the predefined setpoint harvesting driving speed. In second harvesting situation P₂ which is shown, it is also difficult for the operator of harvesting machine 3 to cross gap 16 in crop stand and simultaneously focus on the on-going procedure of transferring the crop material which remains in harvesting machine 3. As a result, transfer device 10 typically remains in previous transfer position X₁—which is depicted in second harvesting situation P2 by a dashed line—as it crosses gap 15 in the crop stand. Using sensors which are known per se and are not depicted here in greater detail, the evaluation and control unit receives signals regarding the harvesting driving speed, the position of transfer device 10, the steering angle of the harvesting machine, and the crop material throughput.

The signals which are registered are forwarded to the evaluation and control unit for evaluation, and they are calculated by the program stored in the evaluation and control unit using the values which were stored previously in the program. As described with reference to FIG. 1, differentiated deductions regarding harvesting situation P₂ may be made based, in particular, on the signals mentioned above, such as the crossing of gaps in the crop stand depicted here, where it is possible for transfer-related losses to take place. Using the program which is stored in the control and evaluation device, the signals which are received by the sensors are evaluated, and an appropriate signal is generated and transmitted to adjusting elements to swivel transfer device 10 against direction of travel FR. If harvesting machine 3 is accelerated past the setpoint harvesting driving speed, the change in the distance from hauling vehicle 4 as compared with the normal harvesting operation and which is likely to occur is calculated based on the acceleration value which is sensed in the acceleration phase, and based on the steering angle of harvesting machine 3, which remains unchanged in the embodiment shown. A signal which is generated accordingly by the evaluation and control unit is transmitted to the adjusting elements to swivel transfer device 10 against direction of travel FR, and transfer device 10 is swiveled against direction of travel FR into transfer position X₂ which is shown here using solid lines, in order to compensate for the change in distance which occurred, and to ensure that the remaining crop material may be transferred reliably.

The swiveling speed is calculated based on the acceleration value at which harvesting machine 10 is accelerated past the setpoint harvesting driving speed. The evaluation and control unit brings about the halt of the swiveling procedure by controlling the adjusting element when sensors (not depicted) which are situated inside the harvesting machine sense that crop material is no longer being conveyed.

It will be understood that each of the elements described above, or two or more together, may also find a useful application in other types of constructions differing from the types described above.

While the invention has been illustrated and described as embodied in a agricultural harvesting machine with a transfer device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An agricultural harvesting machine for picking up and processing crop material, comprising a transfer device which is swivelable about a horizontal axis and a vertical axis, for transferring crop material to a hauling vehicle, said transfer device being swivelable in a manner selected from the group consisting of manually, automatically, and both against a direction of travel of the harvesting machine as a function of operating criteria.

2. The agricultural working machine as defined in claim 1, wherein said transfer device is configured so that its swiveling speed is adjustable.

3. The agricultural harvesting machine as defined in claim 1, wherein said transfer device is configured so that the operating criteria for the swiveling and the adjustment of the swiveling speed of said transfer device include a criterium selected from the group consisting of a harvesting driving speed of the harvesting machine, an acceleration of the harvesting machine, a crop material throughput quantity, a steering angle of the harvesting machine, a change in a relative speed between the harvesting machine and the hauling vehicle, and a combination thereof.

4. The agricultural working machine as defined in claim 1, further comprising an evaluation and control unit, said evaluation and control unit being configured for performing an action selected from the group consisting of the swiveling of the transfer device against the direction of travel of the harvesting machine and the adjustment of the swiveling speed as a function of the operating criteria.

5. The agricultural harvesting machine as defined in claim 4, further comprising means for performing an action selected from the group consisting of the swiveling of the transfer device against the direction of travel, the adjustment of the swiveling speed, and both, in a manner selected from the group consisting of manually by an operator of the agricultural harvesting machine and automatically by said evaluation and control unit.

6. The agricultural harvesting machine as defined in claim 1, further comprising means for ascertaining the operating criteria and configured as sensors that provide signals, as a function of which the swiveling of the transfer device against the direction of travel is controllable.

7. The agricultural harvesting machine as defined in claim 6, wherein said means for ascertaining the operating criteria is an electrooptical device located on a harvesting machine.

8. The agricultural harvesting machine as defined in claim 4, wherein said evaluation and control unit includes control means used in a procedure to swivel the transfer device against the direction of travel of the harvesting machine to control the transfer device in a manner such that an impact point of a crop material flow on a hauling device of the hauling vehicle which was set before swiveling was carried out, remains substantially constant.

9. The agricultural harvesting machine as defined in claim 6, wherein said transfer device is situated in a lateral transfer position during a start of an acceleration phase, which is greater than a setpoint harvesting driving speed, of the harvesting machine, further comprising means for transferring signals which are generated by the sensor in order to determine a harvesting driving speed, to said evaluation and control unit, and means for controlling the swiveling of the transfer device against the direction of travel as a function of the signals that were transmitted.

10. The agricultural harvesting machine as defined in claim 1, further comprising an electronic headland management system configured so that a process for swiveling the transfer device against the direction of travel is integrated in said electronic headland management system which brings about an action selected from the group consisting of the swiveling, the adjustment of a swiveling speed, and both of the transfer device.

11. The agricultural harvesting machine as defined in claim 1, and further comprising means for stopping the swiveling when a conveyance of crop material comes to an end.

12. The agricultural harvesting machine as defined in claim 8, further comprising a touch sensor device, and an additional device selected from the group consisting of an optical reporting device, an acoustic reporting device, and an optical and acoustic reporting device provided in a driver's cab, wherein said evaluation control unit for controlling the swiveling of said transfer device is actuatable using said touch sensor device, and an activated control is displayable using the reporting device in the driver's cab.

13. The agricultural harvesting machine as defined in claim 1, wherein the agricultural harvesting machine is a forage harvester.
